(19) United States
(12) Patent Application Publication
(10) Pub. No.: US 2017/0269373 A1
(43) Pub. Date: Sep. 21, 2017

(54) DISPLAY DEVICE

(71) Applicant: Panasonic Intellectual Property Management Co., Ltd., Osaka (JP)

(72) Inventor: SHIGEO KASAHARA, Hyogo (JP)

(21) Appl. No.: 15/411,732

(22) Filed: Jan. 20, 2017

(30) Foreign Application Priority Data
Mar. 18, 2016 (JP) 2016-056250

(51) Int. Cl. G02B 27/26; G02F 1/13363; H04N 13/04; G02F 1/1335

(52) U.S. Cl. CPC G02B 27/26; G02F 1/133528; G02F 1/13363; H04N 13/0402; G02F 2001/133531; G02F 2001/133562; G02F 2001/133567; G02F 2001/133638; G02F 2413/08; H04N 2213/002

(57) ABSTRACT

A display device includes a rear polarizing plate having a first transmission axis, a rear panel in which a major axis of a liquid crystal molecule in an initial alignment is oriented in a first initial alignment direction, a λ/2 wavelength plate, a front panel in which a major axis of a liquid crystal molecule in an initial alignment is oriented in a second initial alignment direction different from the first initial alignment direction, the front panel being tilted at a predetermined angle with respect to the rear panel, and a front polarizing plate having a second transmission axis oriented in a direction different from the first transmission axis and tilted at the predetermined angle with respect to the rear polarizing plate. The rear polarizing plate, the rear panel, the λ/2 wavelength plate, the front panel, and the front polarizing plate are disposed in this order, the first transmission axis and the first initial alignment direction are perpendicular or parallel to each other, and the second transmission axis and the second initial alignment direction are perpendicular or parallel to each other.

### BACKGROUND

1. Technical Field

The present disclosure relates to a display device formed by stacking a plurality of display panels.

2. Description of the Related Art

There is, for example, a Depth Fused 3D (DFD) display device as a display device that enables 3D display. For example, the display device described in “A Compact Depth-Fused 3-D Display Using a Stack of Two LCDs” by Takada, Suyama, Date, Hiruma, and Nakazawa (The Journal of the Institute of Image Information and Television Engineers, Vol. 58, No. 6, pp. 807-810, 2004) includes two transparent LCD (Liquid Crystal Display) panels which are stacked in front-back direction at a predetermined interval, and enables a 3D image display to an observer by utilizing visual illusion in which two images are integrated to look like one image by changing the luminance ratio of the images displayed on the respective panels. A DFD display device has the advantage of implementing 3D display with a simple configuration and less eye fatigue.

### SUMMARY

A display device according to the present disclosure includes: a first polarizing plate having a first transmission axis; a first display panel in which a major axis of a liquid crystal molecule in an initial alignment is oriented in a first initial alignment direction; a λ/2 wavelength plate; a second display panel in which a major axis of a liquid crystal molecule in an initial alignment is oriented in a second initial alignment direction different from the first initial alignment direction, the second display panel being tilted at a predetermined angle with respect to the first display panel; and a second polarizing plate having a second transmission axis oriented in a direction different from the first transmission axis and tilted at the predetermined angle with respect to the first polarizing plate, wherein the first polarizing plate, the first display panel, the λ/2 wavelength plate, the second display panel, and the second polarizing plate are disposed in this order, the first transmission axis and the first initial alignment direction are perpendicular or parallel to each other, the second transmission axis and the second initial alignment direction are perpendicular or parallel to each other, and a slow axis of the λ/2 wavelength plate is different from the first initial alignment direction and the second initial alignment direction.

### BRIEF DESCRIPTION OF THE DRAWINGS

FIG. 1 is a schematic diagram illustrating a schematic configuration of a display device according to a first exemplary embodiment;

FIG. 2 is a block diagram for describing an electric configuration of the display device according to the first exemplary embodiment;

FIG. 3 is a view for describing moire generated when two display panels are stacked;

FIG. 4 is a diagram illustrating an example of a method of stacking two display panels in the display device according to the first exemplary embodiment;

FIG. 5 is a diagram for describing a problem of a liquid crystal display device according to a comparative example;

FIG. 6 is a diagram schematically illustrating an arrangement of display panels in the liquid crystal display device according to the first exemplary embodiment;

FIG. 7 is a diagram schematically illustrating a configuration of a liquid crystal display device according to a modification of the first exemplary embodiment;

FIG. 8 is a schematic top view illustrating a structure of one cell in an IPS liquid crystal display device;

FIG. 9 is a schematic sectional view illustrating the structure of one cell illustrated in FIG. 8;

FIG. 10 is a schematic diagram for describing the movement of liquid crystal molecules in the front panel illustrated in FIG. 6;

FIG. 11 is a schematic diagram for describing the movement of liquid crystal molecules in the front panel illustrated in FIG. 7;

FIG. 12 is a diagram schematically illustrating a configuration of a liquid crystal display device according to a second exemplary embodiment;

FIG. 13 is a schematic diagram illustrating one example of an orientation relation between a slow axis and an initial alignment direction illustrated in FIG. 12;

FIG. 14 is a schematic diagram illustrating another example of an orientation relation between a slow axis and an initial alignment direction illustrated in FIG. 12;

FIG. 15 is a diagram schematically illustrating a configuration of a liquid crystal display device according to a modification of the second exemplary embodiment; and

FIG. 16 is a schematic diagram illustrating one example of an orientation relation between first and second slow axes and an initial alignment direction illustrated in FIG. 15.

### DETAILED DESCRIPTION

Exemplary embodiments of the present disclosure will be described below in detail with reference to the drawings as necessary. However, more than necessary detailed descriptions will sometimes be omitted. For example, detailed descriptions for matters which have already been well known in the art and redundant descriptions for substantially the same configurations will sometimes be omitted. This is to prevent the following description from becoming unnecessarily redundant to facilitate understanding of a person skilled in the art.

Note that the accompanying drawings and the following description are provided in order for a person skilled in the art to sufficiently understand the present disclosure, and they are not intended to limit the subject matter set forth in the claims.

### First Exemplary Embodiment

[Overall Configuration]

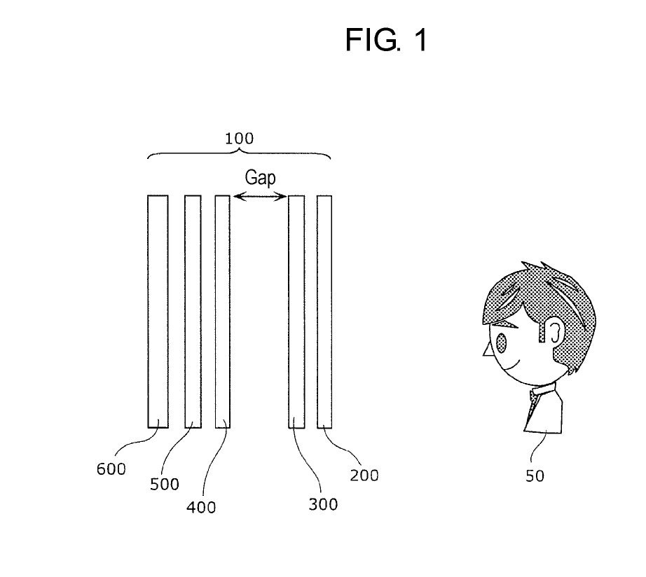

A first exemplary embodiment will be described below with reference to FIGS. 1 to 7.

[Configuration of Display Device]

FIG. 1 is a schematic diagram illustrating a schematic configuration of a display device according to a first exemplary embodiment. Display device 100 illustrated in FIG. 1 is a DFD display device including a plurality of stacked display panels, wherein at least two display panels including front panel 300 and rear panel 400 which transmit visible light are stacked with a predetermined gap therebetween as viewed from observer 50. FIG. 1 illustrates liquid crystal display device 100 as one example. Note that display device 100 is not limited to a liquid crystal display device, and may be an electroluminescence (EL) display device or an electrochromic (EC) display device. Further, examples of the display panel constituting liquid crystal display device 100 include a twisted nematic liquid crystal display, an in-plane switching liquid crystal display, a vertical alignment liquid crystal display, a blue phase liquid crystal display, a ferroelectric liquid crystal display, an Optically Compensated Bend (OCB) liquid crystal display, and a guest-host liquid crystal display. Display device 100 may include two of these display panels in combination as appropriate.

As illustrated in FIG. 1, liquid crystal display device 100 includes front polarizing plate 200, front panel 300, rear panel 400, rear polarizing plate 500, and backlight 600, those of which are stacked in order from front as viewed from observer 50. In the case where display device 100 is a guest-host liquid crystal display device, an EL display device, or an EC display device, front polarizing plate 200 and rear polarizing plate 500 are unnecessary. In addition, in the case where display device 100 is an EL display device, backlight 600 is also unnecessary.

[Electric Configuration of Display Device]

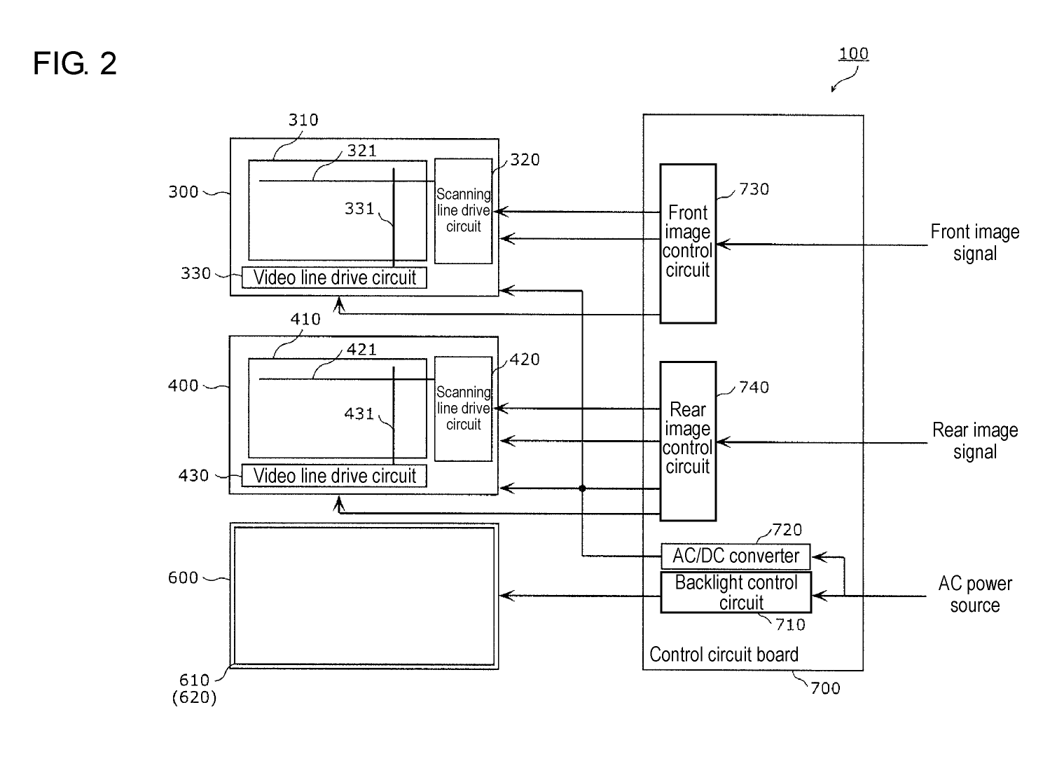

FIG. 2 is a block diagram for describing an electric configuration of the display device according to the first exemplary embodiment. As illustrated in FIG. 2, front panel 300, rear panel 400, and backlight 600 which constitute display device 100 are electrically connected to control circuit board 700.

Front panel 300 includes liquid crystal display unit 310, scanning line drive circuit 320, and video line drive circuit 330. Liquid crystal display unit 310 is provided with a plurality of scanning lines 321 extending from scanning line drive circuit 320 and a plurality of video lines 331 extending from video line drive circuit 330.

Rear panel 400 includes liquid crystal display unit 410, scanning line drive circuit 420, and video line drive circuit 430. Liquid crystal display unit 410 is provided with a plurality of scanning lines 421 extending from scanning line drive circuit 420 and a plurality of video lines 431 extending from video line drive circuit 430.

Backlight 600 includes, for example, LED light source 610, and an optical system such as light guide plate 620 that guides light emitted from LED light source 610 toward rear panel 400 and front panel 300. Note that LED light source 610 in backlight 600 may be of a direct type or an edge type. Backlight 600 may further include a diffusion plate to make light emitted from LED light source 610 uniform.

Control circuit board 700 includes backlight control circuit 710, AC/DC converter 720, front image control circuit 730, and rear image control circuit 740. Control circuit board 700 supplies power and control signals to front panel 300, rear panel 400, and backlight 600.

Backlight control circuit 710 controls backlight 600 on the basis of an alternating current supplied from an alternating-current (AC) power source. Thus, backlight 600 causes LED light source 610 to emit light, thereby radiating visible light to rear panel 400 and front panel 300.

AC/DC converter 720 converts an alternating current (AC) supplied from the AC power source into a direct current (DC). AC/DC converter 720 then supplies the converted DC to front panel 300 and rear panel 400. Thus, front panel 300 and rear panel 400 can perform various operations.

Front image control circuit 730 generates a timing signal, a gradation voltage, a common voltage, etc. on the basis of the acquired front image signal, and supplies the resultant to front panel 300. Front panel 300 receiving the supply described above drives scanning line drive circuit 320 and video line drive circuit 330 to activate scanning lines 321 and video lines 331. Thus, front panel 300 controls alignment of liquid crystal molecules in liquid crystal display unit 310, whereby a video image based on light emitted from backlight 600 can be displayed.

Rear image control circuit 740 generates a timing signal, a gradation voltage, a common voltage, etc. on the basis of the acquired rear image signal, and supplies the resultant to rear panel 400. Rear panel 400 receiving the supply described above drives scanning line drive circuit 420 and video line drive circuit 430 to activate scanning lines 421 and video lines 431. Thus, rear panel 400 controls alignment of liquid crystal molecules in liquid crystal display unit 410, whereby a video image based on light emitted from backlight 600 can be displayed.

The front image signal and the rear image signal indicate images having the same content and different luminances. Therefore, the image of the same content is displayed on front panel 300 and rear panel 400 with different luminances. Thus, a 3D image can be displayed to observer 50 by utilizing an illusion phenomenon in which two images which are the front image displayed on front panel 300 and the rear image displayed on rear panel 400 are integrated to look like a single image.

Front panel 300 and rear panel 400 are provided with various color filters, such as an R (Red) filter, a G (Green) filter, and a B (Blue) filter, according to a predetermined array, to display a color image. The R filter, the G filter, and the B filter are partitioned by a black matrix formed from a material shielding at least visible light in a matrix. Therefore, a stripe pattern is formed by the color filter array and the black matrix. In addition, wirings (scanning lines 321 and scanning lines 421) connecting scanning line drive circuits 320 and 420 and respective pixels, and wirings (video lines 331 and video lines 431) connecting video line drive circuits 330 and 430 and respective pixels are disposed so as to be perpendicular to each other on TFT (Thin Film Transistor) substrates of front panel 300 and rear panel 400 along the black matrix. Therefore, the wirings form regular stripe patterns at equal spaces. In addition, regular stripe patterns at equal spaces are also formed on the color filters and the black matrix partitioning the color filters, besides the wirings. Note that the stripe pattern is not limited to a checkered pattern, and may be a vertical stripe or a horizontal stripe.

[Arrangement of Display Panel]

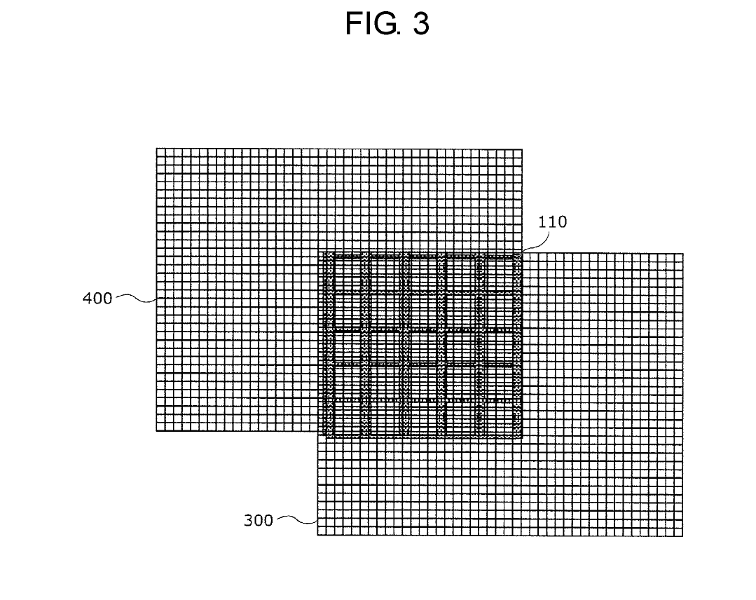

FIG. 3 is a view for describing moire generated when two display panels are stacked. For example, when front panel 300 and rear panel 400 are stacked such that the stripe pattern on front panel 300 and the stripe pattern on rear panel 400 are parallel or perpendicular to each other as illustrated in FIG. 3, observer 50 visually recognizes moire pattern 110 to be generated as illustrated in FIG. 3, for example. If moire pattern 110 is generated, visibility of a video image to be displayed on display device 100 is deteriorated, and thus, it is undesirable.

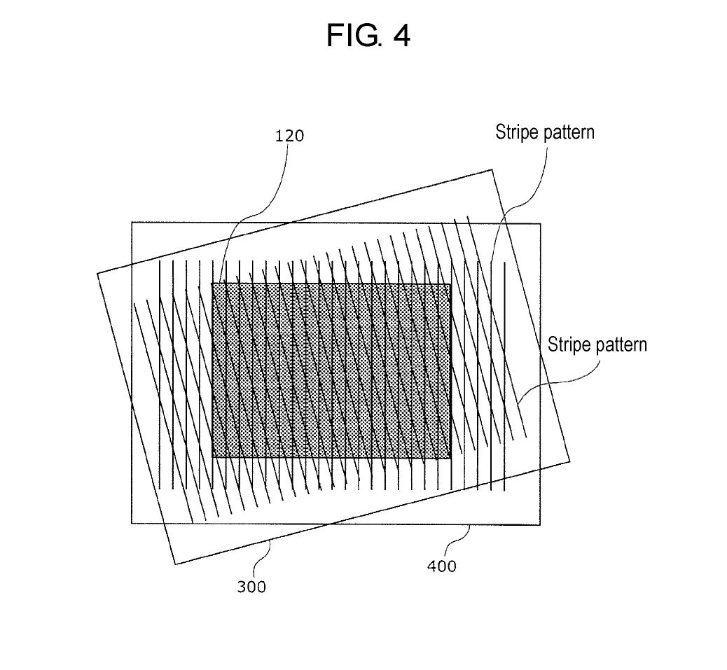

FIG. 4 is a diagram illustrating an example of a method of stacking two display panels in the display device according to the first exemplary embodiment.

As illustrated in FIG. 4, in display device 100 according to the first exemplary embodiment, front panel 300 is disposed to be tilted with respect to rear panel 400 as viewed from observer 50. In this case, the portion of rear panel 400 where an image can be displayed and the portion of front panel 300 where an image can be displayed are overlapped with each other becomes display surface 120. Note that rear panel 400 may be disposed to be tilted with respect to front panel 300.

More specifically, in display device 100 according to the first exemplary embodiment, one of front panel 300 and rear panel 400 is relatively tilted with respect to the other at a predetermined angle, by which the stripe pattern on front panel 300 is relatively tilted with respect to the stripe pattern on rear panel 400 at a predetermined angle. In other words, front panel 300 and rear panel 400 are stacked such that the wirings, the black matrices, and the color filters of front panel 300 and rear panel 400 are overlapped with a predetermined angle.

According to this arrangement, the pitch of moire pattern 110 can be decreased, and the luminance difference between a bright part and a dark part in moire pattern 110 is reduced to lower the contrast. That is, this arrangement enables moire pattern 110 to be hardly visually recognized.

Next, the case where display device 100 is a liquid crystal display device will be described.

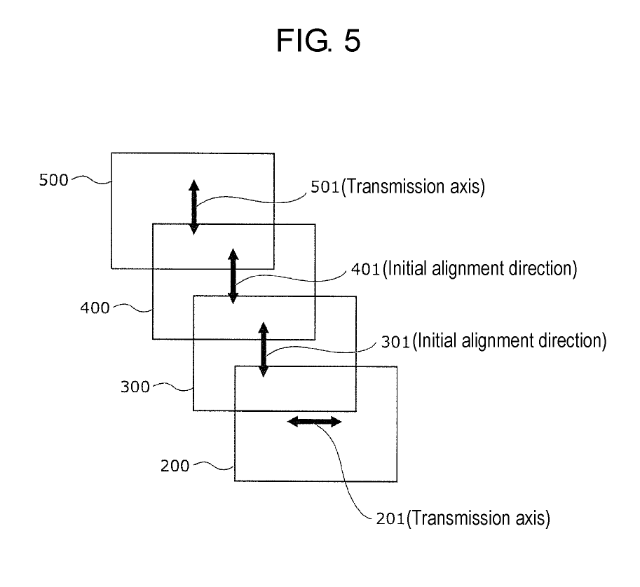

FIG. 5 is a diagram for describing a problem of a liquid crystal display device according to a comparative example. Note that the components same as those in FIG. 1 are identified by the same reference marks, and the detailed description thereof will be omitted.

As illustrated in FIG. 5, the liquid crystal display device according to the comparative example includes front polarizing plate 200, front panel 300, rear panel 400, and rear polarizing plate 500, those of which are stacked in order from front as viewed from observer 50, as in liquid crystal display device 100 according to the first exemplary embodiment. In addition, in the liquid crystal display device according to the comparative example, the respective panels are disposed without being relatively tilted with respect to the other panels.

That is, in the display device according to the comparative example, transmission axis 201 indicating the polarization direction of light passing through front polarizing plate 200 is in the horizontal direction of the screen, and in contrast, transmission axis 501 indicating the polarization direction of light passing through rear polarizing plate 500 is in the longitudinal direction of the screen (the direction vertical to transmission axis 201), as illustrated in FIG. 5. In addition, initial alignment direction 301 of liquid crystal molecules in front panel 300 in initial alignment and initial alignment direction 401 of liquid crystal molecules in rear panel 400 in initial alignment are both in the longitudinal direction of the screen.

Therefore, in the case where front panel 300 and rear panel 400 are brought into a black display state in the liquid crystal display device according to the comparative example, polarized light passing through rear polarizing plate 500 reaches front polarizing plate 200 through rear panel 400 and front panel 300 without changing the polarization direction thereof. Since transmission axis 201 of front polarizing plate 200 is at right angle to the polarization axis of the polarized light reaching front polarizing plate 200, the polarized light cannot pass through front polarizing plate 200. In this way, the liquid crystal display device according to the comparative example implements a black display. However, since the stripe patterns by wirings, black matrices, and color filters on rear panel 400 and front panel 300 are parallel or vertical to each other, moire is generated.

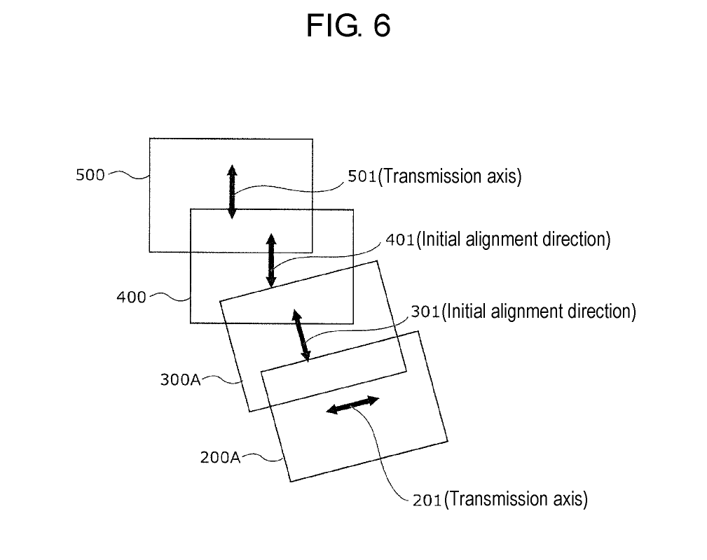

On the other hand, FIG. 6 is a diagram schematically illustrating an arrangement of display panels in the liquid crystal display device according to the first exemplary embodiment. Note that the components same as those in FIGS. 1 and 5 are identified by the same reference marks, and the detailed description thereof will be omitted.

As illustrated in FIG. 6, liquid crystal display device 100 according to the present exemplary embodiment includes front polarizing plate 200A, front panel 300A, rear panel 400, and rear polarizing plate 500, those of which are stacked in order from front as viewed from an observer. In addition, in display device 100, front panel 300A and front polarizing plate 200A are disposed to be relatively tilted with respect to rear panel 400 and rear polarizing plate 500 to reduce the occurrence of moire. In this way, in display device 100, stripe patterns of wirings, black matrices, and color filters on front panel 300A and rear panel 400 are overlapped with a predetermined angle, whereby the occurrence of moire can be reduced.

### Effects, Etc.

As described above, according to the display device of the present exemplary embodiment, the occurrence of moire can be reduced.

More specifically, two display panels need to be stacked to implement 3D display by DFD method in the display device according to the present exemplary embodiment. However, when a plurality of display panels such as LCD panels is to be stacked, moire (interference fringe) is generated. In an LCD panel or the like, wirings, color filters, and a black matrix partitioning color filters on a TFT substrate form a regular stripe pattern (vertical stripe, horizontal stripe, checkered stripe, etc.) at equal spaces, and the stripe patterns on the LCD panels which are stacked interfere with each other to cause moire (interference fringe). In view of this, in the display device according to the present exemplary embodiment, a plurality of display panels including front panel 300A and rear panel 400 are disposed to be relatively tilted. Thus, the stripe patterns of the display panels which are stacked can be overlapped with each other at a predetermined angle, whereby the occurrence of moire can be reduced.

### Modification

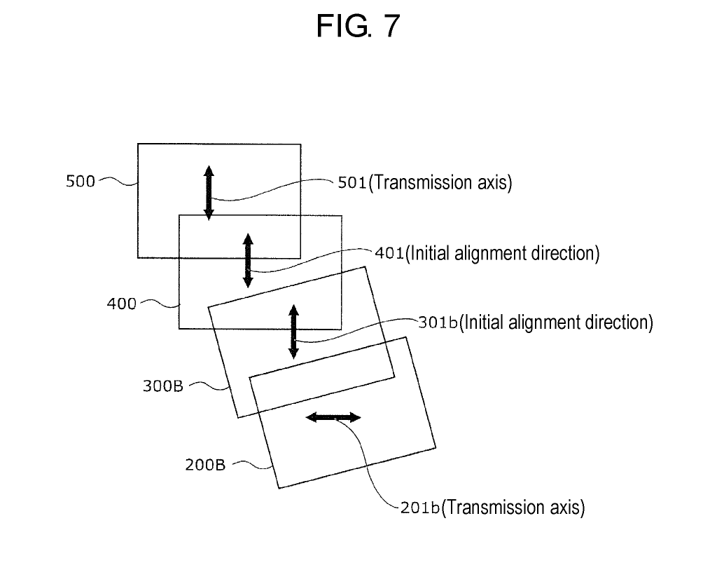

FIG. 7 is a diagram schematically illustrating a configuration of a liquid crystal display device according to a modification of the first exemplary embodiment. Note that the components same as those in FIG. 6 are identified by the same reference marks, and the detailed description thereof will be omitted.

In liquid crystal display device 100 illustrated in FIG. 6, it is considered that black display looks whitish. Specifically, in the case where both front panel 300A and rear panel 400 are brought into a black display state in liquid crystal display device 100 illustrated in FIG. 6, polarized light passing through rear polarizing plate 500 reaches front panel 300A through rear panel 400 without changing the polarization direction thereof. On the other hand, since front panel 300A and rear panel 400 are disposed to have a predetermined angle, linearly polarized light reaching front panel 300A is converted into elliptically polarized light due to birefringence, passes through front panel 300A, and reaches front polarizing plate 200A. In the polarized light that is converted into elliptically polarized light, a polarized light component in the direction of transmission axis 201 of front polarizing plate 200A may pass through front polarizing plate 200A. As described above, in liquid crystal display device 100 illustrated in FIG. 6, the occurrence of moire can be reduced, but the contrast of the black display is considered to be lowered due to the phenomenon in which the black display looks whitish.

On the other hand, the liquid crystal display device according to the present modification illustrated in FIG. 7 includes front polarizing plate 200B, front panel 300B, rear panel 400, and rear polarizing plate 500, those of which are stacked in order from front as viewed from observer, as in liquid crystal display device 100 illustrated in FIG. 6. In addition, in the liquid crystal display device according to the present modification, front panel 300B and front polarizing plate 200B are disposed to be relatively tilted with respect to rear panel 400 and rear polarizing plate 500 as in FIG. 6. Furthermore, the liquid crystal display device according to the present modification is configured such that transmission axis 201b of front polarizing plate 200B and transmission axis 501 of rear polarizing plate 500 are perpendicular to each other, and initial alignment direction 301b of front panel 300B and initial alignment direction 401 of rear panel 400 are perpendicular to transmission axis 201b. In other words, the liquid crystal display device according to the present modification is configured such that, regardless of the predetermined angle made by the stripe patterns, formed from wirings, black matrices, and color filters, on front panel 300B and rear panel 400, initial alignment direction 301b of liquid crystal molecules in front panel 300B and transmission axis 201b of front polarizing plate 200B are oriented in a predetermined direction.

According to this configuration, the polarized light passing through rear polarizing plate 500 reaches front polarizing plate 200B through rear panel 400 without changing the polarization direction thereof, but cannot pass through front polarizing plate 200B, because transmission axis 201b of front polarizing plate 200B is at right angle to the polarization axis of the polarized light reaching front polarizing plate 200B.

Accordingly, the liquid crystal display device in the present modification can reduce the occurrence of moire and can prevent the phenomenon in which a black display looks whitish.

Notably, the initial alignment direction of liquid crystal and the orientation of the transmission axis of the polarizing plate illustrated in FIGS. 6 and 7 are merely one example, and even if different orientations are applied depending on the type of liquid crystal, the phenomenon in which a black display looks whitish can be prevented by applying the similar technical concept.

### Second Exemplary Embodiment

The second exemplary embodiment describes a display device having a configuration different from the configuration of the display device in the modification of the first exemplary embodiment, that is, a display device having a configuration different from the configuration of the liquid crystal display device that can reduce the occurrence of moire and can prevent the phenomenon in which a black display looks whitish in the modification of the first exemplary embodiment.

Hereinafter, a point to be improved of front panel 300B composing the liquid crystal display device illustrated in FIG. 7 will firstly be described, and then, the liquid crystal display device for resolving the point to be improved according to the present embodiment will be described.

### Point to be Improved

Compared to front panel 300A composing the liquid crystal display device illustrated in FIG. 6, front panel 300B composing the liquid crystal display device illustrated in FIG. 7 is a special display panel, and entails a problem of increased cost. The display panel illustrated in FIG. 6 can be said to be a general display panel in which the direction of the long side of front panel 300A and initial alignment direction 301 thereof are vertical to each other. In contrast, the display panel illustrated in FIG. 7 can be said to be a special panel in which the direction of the long side of front panel 300B and initial alignment direction 301b thereof are not vertical to each other. Therefore, production cost for front panel 300B is higher than that for a general display panel.

In addition, front panel 300B composing the liquid crystal display device illustrated in FIG. 7 has a problem such that, when a voltage is applied to liquid crystal molecules therein, front panel 300B may have an area where the liquid crystal molecules are aligned differently. Therefore, scanning line drive circuit 320, video line drive circuit 330, and front image control circuit 730, which are exclusively adapted to front panel 300B, are needed, and thus, production cost is increased.

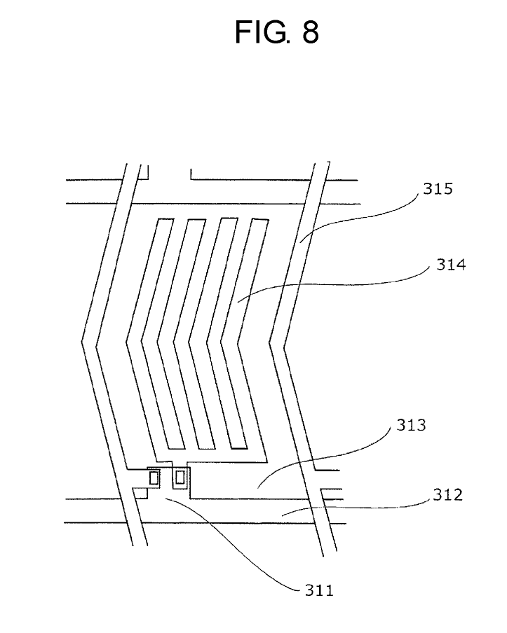

Hereinafter, the problem of front panel 300B in which, when a voltage is applied to liquid crystal molecules therein, front panel 300B may have an area where the liquid crystal molecules are aligned differently will specifically be described with reference to FIGS. 8 to 11.

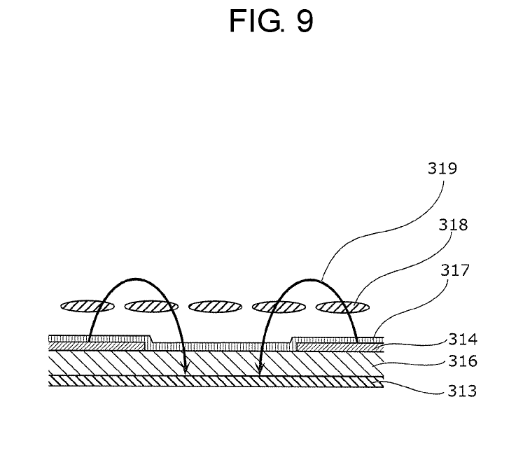

FIG. 8 is a schematic top view illustrating a structure of one cell in an IPS liquid crystal display device. FIG. 9 is a schematic sectional view illustrating the structure of one cell illustrated in FIG. 8.

The structure of one cell illustrated in FIG. 8 is also applicable to front panel 300 of the liquid crystal display device illustrated in FIG. 5 according to the comparative example and front panel 300B of the liquid crystal display device illustrated in FIG. 7 according to the modification of the first exemplary embodiment. As illustrated in FIG. 8, the structure of one cell includes TFT 311, gate electrode 312, common electrode 313, pixel electrode 314, and drain electrode 315. In addition, as illustrated in FIG. 9, the structure of one cell includes common electrode 313, insulating film 316 formed on common electrode 313, pixel electrode 314 formed on insulating film 316, alignment film electrode 317 provided to cover pixel electrode 314 and insulating film 316, and liquid crystal molecules 318 laid horizontally on alignment film electrode 317. It is to be noted that, since the respective components of one cell illustrated in FIGS. 8 and 9 have already been well known, the detailed description thereof will be omitted.

This one cell generates an electric field in direction 319 illustrated in FIG. 9, for example, by an application of a voltage to alignment film electrode 317 and common electrode 313, thereby rotating long axes (alignment direction) of liquid crystal molecules 318. Since the liquid crystal molecules illustrated in FIG. 9 are of IPS type, they are rotated in left-right direction (horizontal direction) in FIG. 9.

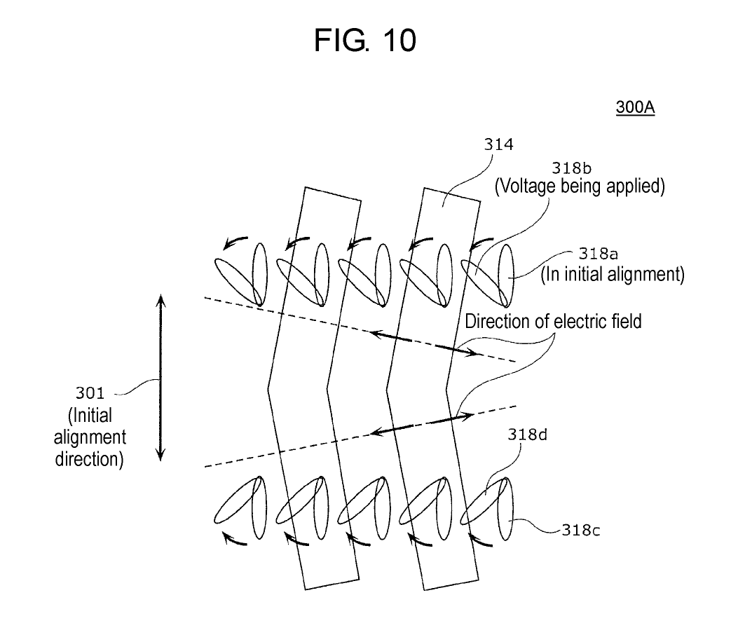

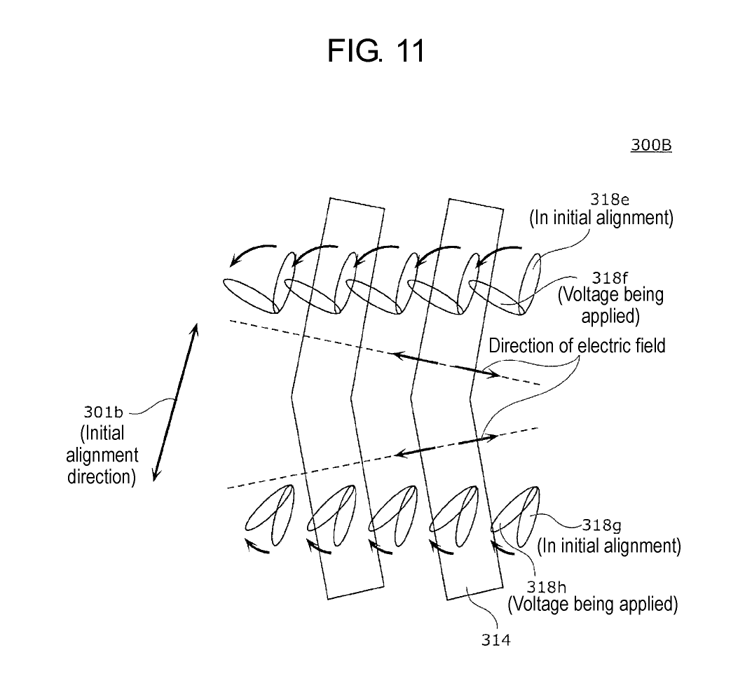

FIG. 10 is a schematic diagram for describing the movement of liquid crystal molecules in the front panel illustrated in FIG. 6. FIG. 11 is a schematic diagram for describing the movement of liquid crystal molecules in the front panel illustrated in FIG. 7. Note that the components same as those in FIGS. 8 and 9 are identified by the same reference marks, and the detailed description thereof will be omitted. In addition, it is described below that the liquid crystal display device illustrated in FIGS. 10 and 11 are both of an IPS type, and the structure of one cell in pixel electrode 314 or the like is the same.

As illustrated in FIG. 10, liquid crystal molecules 318a in the initial alignment and the major axis directions (alignment direction) of liquid crystal molecules 318c are vertical to the arrangement direction (horizontal direction in the drawing) of pixel electrode 314 on front panel 300A. Therefore, it is understood that, when a voltage is applied, liquid crystal molecules 318a and liquid crystal molecules 318c in the initial alignment are rotated to the positions indicated as liquid crystal molecules 318b and liquid crystal molecules 318d when a voltage is applied, and the rotation angles thereof are the same.

On the other hand, as illustrated in FIG. 11, the major axis directions (alignment direction) of liquid crystal molecules 318e and liquid crystal molecules 318g in the initial alignment are not vertical to the arrangement direction (horizontal direction in the drawing) of pixel electrode 314 but tilted at a predetermined angle on front panel 300B. Therefore, it is understood that, when a voltage is applied, liquid crystal molecules 318e and liquid crystal molecules 318g in the initial alignment are rotated to the positions indicated as liquid crystal molecules 318f and liquid crystal molecules 318h when a voltage is applied, but the rotation angles thereof are not the same. In the example illustrated in FIG. 11, the rotation angle of liquid crystal molecules 318f when a voltage is applied is larger than the rotation angle of liquid crystal molecules 318h when a voltage is applied. Accordingly, when a voltage is applied, the rotation angle of the liquid crystal molecules illustrated in the upper section is larger than the rotation angle of the liquid crystal molecules illustrated in the lower section in FIG. 11.

As described above, front panel 300B has the problem in which, when a voltage is applied to liquid crystal molecules therein, front panel 300B has an area where the liquid crystal molecules are aligned differently.

[Configuration and Arrangement of Display Device]

Next, the liquid crystal display device according to the present exemplary embodiment for resolving the point to be improved in front panel 300B will be described. Specifically, an example different from the liquid crystal display device that can reduce the occurrence of moire and can prevent the phenomenon in which a black display looks whitish according to the modification of the first exemplary embodiment will be described.

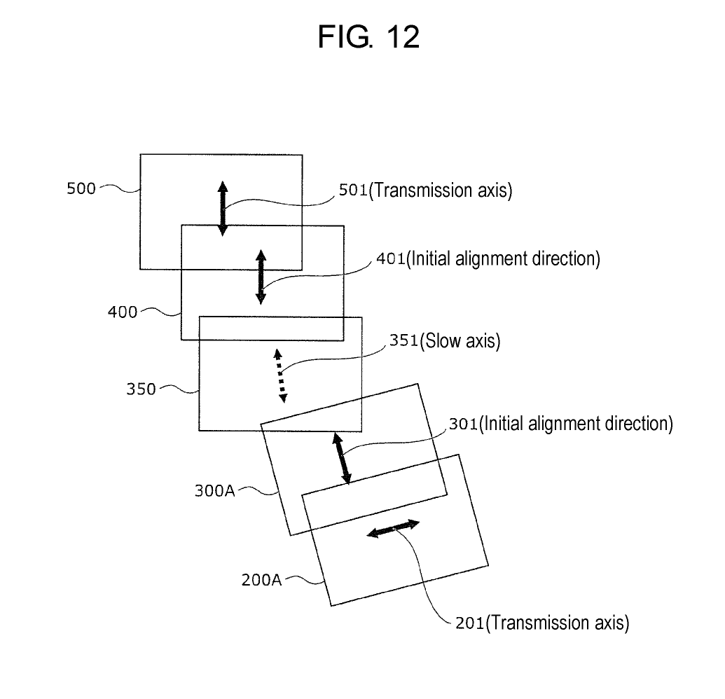

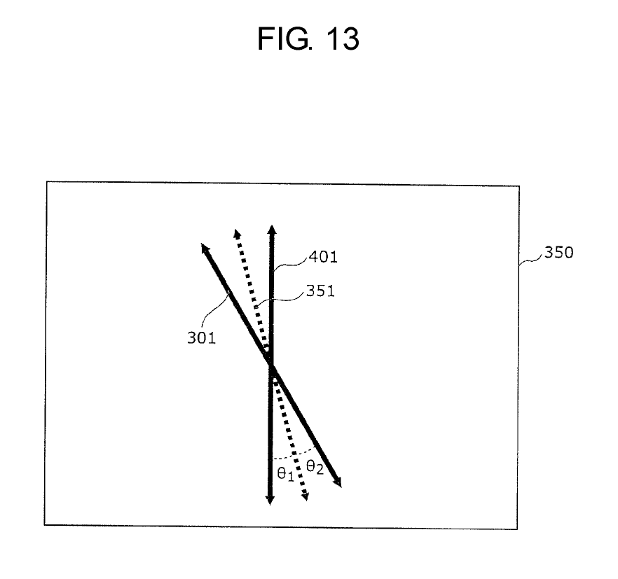

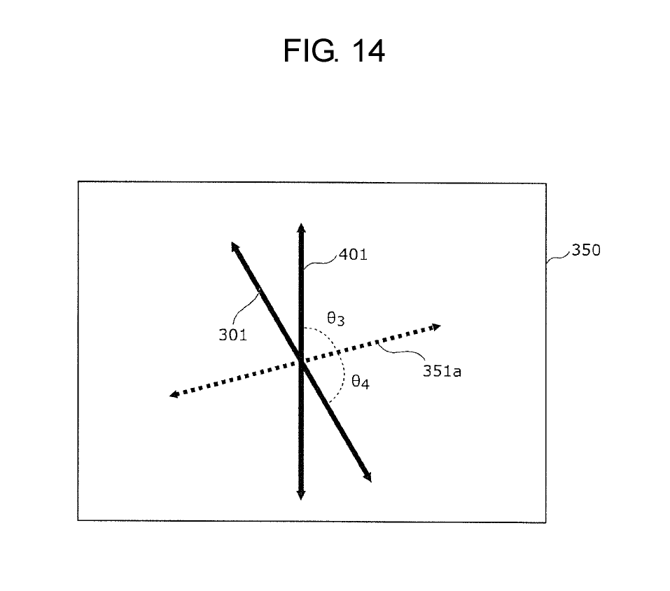

FIG. 12 is a diagram schematically illustrating the configuration of the liquid crystal display device according to the second exemplary embodiment. In addition, FIG. 13 is a schematic diagram illustrating one example of an orientation relation between a slow axis and an initial alignment direction illustrated in FIG. 12. FIG. 14 is a schematic diagram illustrating another example of an orientation relation between the slow axis and the initial alignment direction illustrated in FIG. 12. Note that the components same as those in FIG. 6 are identified by the same reference marks, and the detailed description thereof will be omitted.

The liquid crystal display device illustrated in FIG. 12 according to the present exemplary embodiment includes front polarizing plate 200A, front panel 300A, λ/2 wavelength plate 350, rear panel 400, and rear polarizing plate 500. The display device illustrated in FIG. 12 is different from the liquid crystal display device illustrated in FIG. 6 in that λ/2 wavelength plate 350 is further provided between front panel 300A and rear panel 400.

That is, the display device illustrated in FIG. 12 includes front polarizing plate 200A, front panel 300A, λ/2 wavelength plate 350, rear panel 400, and rear polarizing plate 500, those of which are stacked in order from front as viewed from an observer. In addition, in the display device, front panel 300A and front polarizing plate 200A are disposed to be tilted (relatively tilted) with respect to rear panel 400 and rear polarizing plate 500 at a predetermined angle to reduce the occurrence of moire, as in the display device illustrated in FIG. 6.

More specifically, rear polarizing plate 500 is, for example, a first polarizing plate, and has transmission axis 501 (first transmission axis). Rear panel 400 is, for example, a first display panel, and major axes of liquid crystal molecules in an initial alignment are oriented in initial alignment direction 401. Transmission axis 501 and initial alignment direction 401 are perpendicular or parallel to each other (parallel in FIG. 12). Front panel 300A is a second display panel, for example. Front panel 300A has initial alignment direction 301 different from initial alignment direction 401, and is tilted with respect to rear panel 400 at a predetermined angle. Front polarizing plate 200A is a second polarizing plate, for example. Front polarizing plate 200A has transmission axis 201 oriented in a direction different from the direction of transmission axis 501, and is tilted with respect to rear polarizing plate 500 at a predetermined angle. Transmission axis 201 and initial alignment direction 301 are perpendicular or parallel to each other (perpendicular in FIG. 12).

According to this arrangement, in the display device, stripe patterns of wirings, black matrices, and color filters on front panel 300A and rear panel 400 are overlapped with a predetermined angle, whereby the occurrence of moire can be reduced.

Furthermore, in the display device illustrated in FIG. 12, λ/2 wavelength plate 350 is interposed between front panel 300A and rear panel 400. In addition, it is configured such that slow axis 351 of λ/2 wavelength plate 350 is different from (does not coincide with) initial alignment direction 401 and initial alignment direction 301.

λ/2 wavelength plate 350 is formed from a film made by utilizing a material such as crystal, mica, or a resin having birefringence, and generates a phase difference of π(=λ/2) on polarization plane (direction of electric field oscillation) of incident light. Slow axis 351 of λ/2 wavelength plate 350 is an optical axis that is the highest orientation out of birefringence orientations, of a substance and in which the index of refraction of polarized light is the highest in a plane vertical to the advancing direction of light.

More specifically, it is supposed that, in FIG. 12, the angle made by initial alignment direction 401 and initial alignment direction 301 is defined as θa, and the angle made by initial alignment direction 401 and slow axis 351 is defined as θb. In this case, polarized light which is tilted at angle θb with respect to slow axis 351 is incident on λ/2 wavelength plate 350. λ/2 wavelength plate 350 emits the incident polarized light in the state of being further tilted at angle θb. That is, λ/2 wavelength plate 350 emits polarized light with an angle of 2×θb with respect to initial alignment direction 401.

Accordingly, the angle made by initial alignment direction 301 and polarized light (polarized light incident on front panel 300A) emitted from A/2 wavelength plate 350 becomes (θa−2×θb). Compared to the case where A/2 wavelength plate 350 is not used, the shift between initial alignment direction 301 and polarized light emitted from λ/2 wavelength plate 350 is reduced, and this can prevent the phenomenon in which a black display looks whitish.

If angle θb is set to be a half of angle θa, polarized light (polarized light incident on front panel 300A) emitted from λ/2 wavelength plate 350 becomes parallel to initial alignment direction 301, and this can further prevent the phenomenon in which a black display looks whitish.

In addition, a plurality of λ/2 wavelength plates 350 may be provided to the display device as described below. However, compared to the case where a plurality of λ/2 wavelength plates is provided, the configuration in which a single λ/2 wavelength plate 350 is provided can reduce angular variation of polarized light, thereby being capable of reducing an error. This is because, if angular variation of polarized light is large, an error is also increased.

The configuration having the highest effect of preventing the phenomenon in which a black display looks whitish, i.e., the configuration in which angle θb is set as a half of angle θa, will be described below in detail with reference to FIG. 13.

In FIG. 13, it is configured such that slow axis 351 is located between initial alignment direction 401 and initial alignment direction 301. In addition, angle θ1 that slow axis 351 forms with initial alignment direction 401 is equal to angle θ2 that slow axis 351 forms with initial alignment direction 301, that is, angle θ1 is a half of the angle (θ1+θ2) between initial alignment direction 301 and initial alignment direction 401.

In the example in FIG. 13, the angle (θ1+θ2) that initial alignment direction 301 forms with initial alignment direction 401 is an acute angle. However, it is not limited thereto. For example, as illustrated in FIG. 14, the angle (θ3+θ4) that initial alignment direction 301 forms with initial alignment direction 401 may be an obtuse angle. In this case as well, the configuration in which angle θ3 that slow axis 351a forms with initial alignment direction 401 is equal to angle θ4 that slow axis 351a forms with initial alignment direction 301, that is, angle θ3 is a half of the angle (θ3+θ4) between initial alignment direction 301 and initial alignment direction 401, can provide the highest effect of preventing the phenomenon in which a black display looks whitish. Notably, if the angle that initial alignment direction 301 forms with initial alignment direction 401 is an obtuse angle, the angular variation by the λ/2 wavelength plate is increased. In view of this, the angle to be formed is preferably an acute angle as illustrated in FIG. 13.

According to this configuration, in the case where both front panel 300A and rear panel 400 are brought into a black display state in the display device illustrated in FIG. 12, polarized light passing through rear polarizing plate 500 passes through rear panel 400 without changing the polarization direction thereof. Since the angle made by initial alignment direction 401 and slow axis 351 of λ/2 wavelength plate 350 is θ1, the polarized light from rear panel 400 is incident as being tilted at angle θ1 with respect to slow axis 351 of λ/2 wavelength plate 350. The polarization direction of the incident polarized light is further changed by λ/2 wavelength plate 350 at angle θ1, and then, the polarized light reaches front panel 300A.

Accordingly, in the display device in which front panel 300A is tilted at a predetermined angle (θ1+θ2) with respect to rear panel 400, the tilt of the polarized light incident on front panel 300A becomes 2×θ1 with respect to initial alignment direction 401 by slow axis 351, and since θ1=θ2, the polarized light emitted from slow axis 351 is changed to be parallel to initial alignment direction 301 of front panel 300A. Therefore, the polarized light passing through λ/2 wavelength plate 350 passes through front panel 300A as it is to reach front polarizing plate 200A, but cannot pass through polarizing plate 200A, because transmission axis 201 of front polarizing plate 200A is at right angle to the polarization axis of the polarized light. That is, the phenomenon in which black display looks whitish can be prevented.

### Effects, Etc.

As described above, the liquid crystal display device in the present exemplary embodiment can reduce the occurrence of moire and can prevent the phenomenon in which a black display looks whitish.

More specifically, the display device according to the present exemplary embodiment includes: rear polarizing plate 500 (first polarizing plate) having transmission axis 501 (first transmission axis); rear panel 400 (first display panel) in which a major axis of a liquid crystal molecule in an initial alignment is oriented in initial alignment direction 401 (first initial alignment direction); λ/2 wavelength plate 350; front panel 300A (second display panel) in which a major axis of a liquid crystal molecule in an initial alignment is oriented in initial alignment direction 301 (second initial alignment direction) different from initial alignment direction 401 (first initial alignment direction), front panel 300A being tilted at a predetermined angle with respect to rear panel 400 (first display panel); and front polarizing plate 200A (second polarizing plate) having transmission axis 201 (second transmission axis) oriented in a direction different from transmission axis 501 (first transmission axis) and tilted at the predetermined angle with respect to rear polarizing plate 500 (first polarizing plate). Rear polarizing plate 500 (first polarizing plate), rear panel 400 (first display panel), λ/2 wavelength plate 350, front panel 300A (second display panel), and front polarizing plate 200A (second polarizing plate) are disposed in this order; transmission axis 501 (first transmission axis) and initial alignment direction 401 (first initial alignment direction) are perpendicular or parallel to each other; and transmission axis 201 (second transmission axis) and initial alignment direction 301 (second initial alignment direction) are perpendicular or parallel to each other. A slow axis of λ/2 wavelength plate 350 is different from initial alignment direction 401 (first initial alignment direction) and initial alignment direction 301 (second initial alignment direction).

According to this configuration, a shift between initial alignment direction 301 (second initial alignment direction) and an axis of light emitted from λ/2 wavelength plate 350 is reduced, whereby a phenomenon in which a black display looks whitish can be prevented.

The angle that slow axis 351 of λ/2 wavelength plate 350 forms with initial alignment direction 401 (first initial alignment direction) may be set to be a half of the angle that initial alignment direction 301 (second initial alignment direction) forms with initial alignment direction 401 (first initial alignment direction).

In addition, the angle that initial alignment direction 301 (second initial alignment direction) forms with initial alignment direction 401 (first initial alignment direction) may be set as an acute angle.

As described above, according to the present exemplary embodiment, a liquid crystal display device that can reduce the occurrence of moire and can prevent the phenomenon in which a black display looks whitish can be implemented.

### Modification

The above-described second exemplary embodiment describes the configuration of the display device in which a single λ/2 wavelength plate is provided between front panel 300A and rear panel 400. However, the configuration is not limited thereto. Two or more λ/2 wavelength plates may be provided between front panel 300A and rear panel 400. The present modification describes the case where two λ/2 wavelength plates are provided between front panel 300A and rear panel 400.

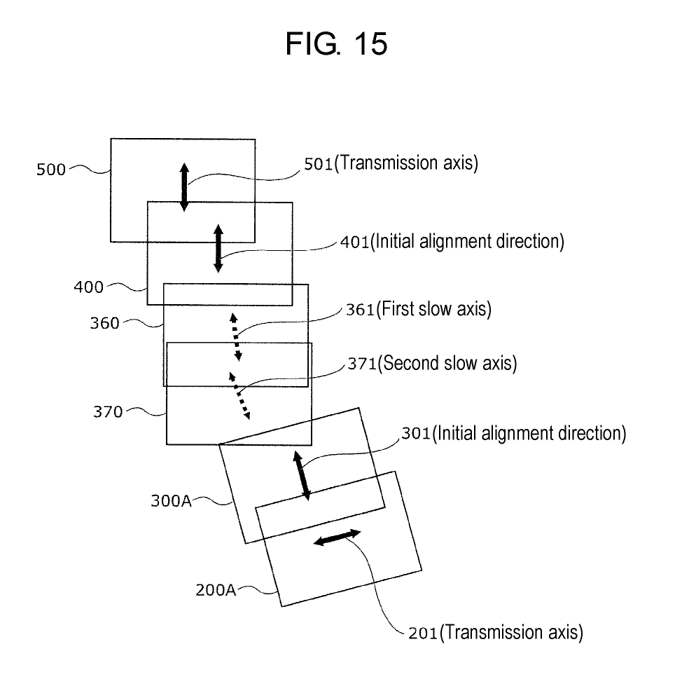

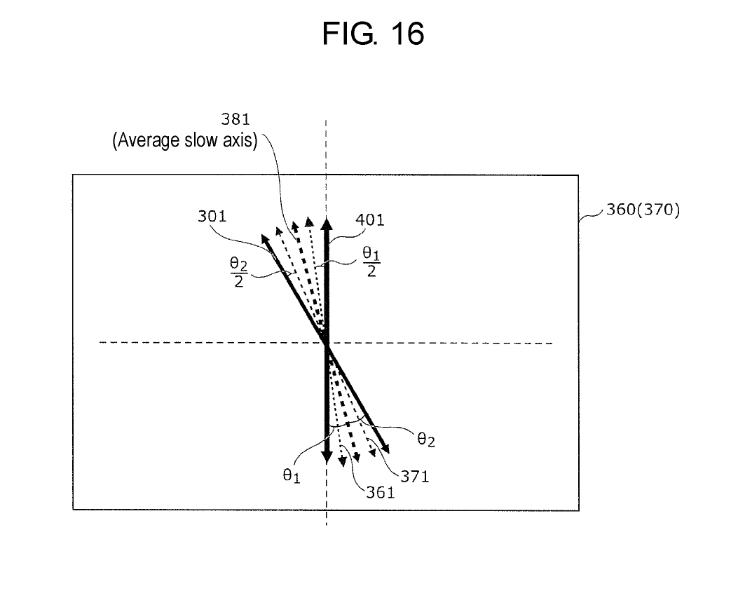

FIG. 15 is a diagram schematically illustrating a configuration of a liquid crystal display device according to the modification of the second exemplary embodiment. FIG. 16 is a schematic diagram illustrating one example of an orientation relation between first and second slow axes and an initial alignment direction illustrated in FIG. 15. Note that the components same as those in FIGS. 12 and 13 are identified by the same reference marks, and the detailed description thereof will be omitted.

The liquid crystal display device illustrated in FIG. 15 is different from the liquid crystal display device illustrated in FIG. 12 in that two λ/2 wavelength plates which are first λ/2 wavelength plate 360 and second λ/2 wavelength plate 370 are provided between front panel 300A and rear panel 400. Further, the display device is configured such that first slow axis 361 of first λ/2 wavelength plate 360 and second slow axis 371 of second λ/2 wavelength plate 370 are different from (do not coincide with) initial alignment direction 401 and initial alignment direction 301, and further, first slow axis 361 and second slow axis 371 are different from each other (do not coincide with each other).

As in λ/2 wavelength plate 350, first λ/2 wavelength plate 360 and second λ/2 wavelength plate 370 are formed from a film made by utilizing a material such as crystal, mica, or a resin having birefringence, and generates a phase difference of π(=λ/2) on polarization plane (direction of electric field oscillation) of incident light.

In the present modification, the display device is configured such that first slow axis 361 of first λ/2 wavelength plate 360 and second slow axis 371 of second λ/2 wavelength plate 370 are located between initial alignment direction 401 and initial alignment direction 301, as illustrated in FIG. 16. It is described below that the position of polarized light passing through first λ/2 wavelength plate 360 is defined as average slow axis 381, an angle that average slow axis 381 forms with initial alignment direction 401 is defined as θ1, and an angle that average slow axis 381 forms with initial alignment direction 301 is defined as θ2. In this case, the angle that second slow axis 371 forms with initial alignment direction 301 is (θ2/2), and the angle that first slow axis 361 forms with initial alignment direction 401 is (θ1/2). The case of θ1=θ2 is most effective to prevent the phenomenon in which a black display looks whitish.

More specifically, the angle (θ1/2) that first slow axis 361 forms with initial alignment direction 401 is a half of angle (θ1) that average slow axis 381 forms with initial alignment direction 401. In addition, the angle (θ2/2) that second slow axis 371 forms with average slow axis 381 is a half of angle θ2 that initial alignment direction 301 forms with average slow axis 381. The case of θ1=θ2 is most effective to prevent the phenomenon in which a black display looks whitish.

In the example in FIGS. 15 and 16, the angle (θ1+θ2) that initial alignment direction 301 forms with initial alignment direction 401 is an acute angle. However, it is not limited thereto. For example, the angle may be an obtuse angle as illustrated in FIG. 14, and in this case as well, the similar relation is established.

According to this configuration, in the case where both front panel 300A and rear panel 400 are brought into a black display state in the display device illustrated in FIG. 15, polarized light passing through rear polarizing plate 500 passes through rear panel 400 without changing the polarization direction thereof. In the case of θ1=θ2, the angle made by initial alignment direction 401 and first slow axis 361 of first λ/2 wavelength plate 360 is (θ1/2). Therefore, the polarized light from rear panel 400 is incident as being tilted at angle (θ1/2) with respect to first slow axis 361 of first λ/2 wavelength plate 360. The polarization direction of the incident polarized light is further changed by θ1/2 by first λ/2 wavelength plate 360 to be along average slow axis 381, and the resultant polarized light is incident on second λ/2 wavelength plate 370. Since the angle made by average slow axis 381 and second slow axis 371 of second λ/2 wavelength plate 370 is (θ1/2), the polarized light from first λ/2 wavelength plate 360 is incident as being tilted at angle (θ1/2) with respect to second slow axis 371 of second λ/2 wavelength plate 370. The polarization direction of the incident polarized light is further changed by second λ/2 wavelength plate 370 by θ1/2, and then, the resultant polarized light reaches front panel 300A.

Specifically, the polarized light from rear panel 400 reaches front panel 300A in the state in which the polarization direction thereof is changed in two steps by first λ/2 wavelength plate 360 and second λ/2 wavelength plate 370 by an angle of 2θ1, that is, changed to be parallel to initial alignment direction 301 of front panel 300A.

Therefore, the polarized light passing through first λ/2 wavelength plate 360 and second λ/2 wavelength plate 370 passes through front panel 300A without changing the polarization direction thereof to reach front polarizing plate 200A, but cannot pass through front polarizing plate 200A, because transmission axis 201 of front polarizing plate 200A is at right angle to the polarization axis of the polarized light. That is, the phenomenon in which black display looks whitish can be prevented.

### Effects, Etc.

As described above, the liquid crystal display device in the present modification can reduce the occurrence of moire and can prevent the phenomenon in which a black display looks whitish.

More specifically, the display device according to the present modification includes: rear polarizing plate 500 (first polarizing plate) having transmission axis 501 (first transmission axis); rear panel 400 (first display panel) in which a major axis of a liquid crystal molecule in an initial alignment is oriented in initial alignment direction 401 (first initial alignment direction); λ/2 wavelength plate 350; front panel 300A (second display panel) in which a major axis of a liquid crystal molecule in an initial alignment is oriented in initial alignment direction 301 (second initial alignment direction) different from initial alignment direction 401 (first initial alignment direction), front panel 300A being tilted at a predetermined angle with respect to rear panel 400 (first display panel); and front polarizing plate 200A (second polarizing plate) having transmission axis 201 (second transmission axis) oriented in a direction different from transmission axis 501 (first transmission axis) and tilted at the predetermined angle with respect to rear polarizing plate 500 (first polarizing plate). Rear polarizing plate 500 (first polarizing plate), rear panel 400 (first display panel), λ/2 wavelength plate 350, front panel 300A (second display panel), and front polarizing plate 200A (second polarizing plate) are disposed in this order; transmission axis 501 (first transmission axis) and initial alignment direction 401 (first initial alignment direction) are perpendicular or parallel to each other; and transmission axis 201 (second transmission axis) and initial alignment direction 301 (second initial alignment direction) are perpendicular or parallel to each other. A slow axis of λ/2 wavelength plate 350 is different from initial alignment direction 401 (first initial alignment direction) and initial alignment direction 301 (second initial alignment direction).

According to this configuration, even if angular variation for each wavelength is different on the first λ/2 wavelength plate, the variation can be adjusted by the second λ/2 wavelength plate, whereby an effect is provided such that an angular adjustment of polarized light is easily enabled, compared to the case where a single λ/2 wavelength plate is used.

In this case, the λ/2 wavelength plate may include a plurality of λ/2 wavelength plates.

In addition, the angle that initial alignment direction 301 (second initial alignment direction) forms with initial alignment direction 401 (first initial alignment direction) may be set as an acute angle.

### Other Exemplary Embodiments

As presented above, the first and second exemplary embodiments have been described as an example of the technology disclosed in the present application. However, the technology in the present disclosure is not limited thereto, and is applicable to exemplary embodiments to which modification, replacement, addition, omission, or the like is made as appropriate. In addition, the constituent elements described in the first exemplary embodiment can be combined to form a new exemplary embodiment.

For example, in the first and second exemplary embodiments, two display panels are stacked. However, the configuration is not limited thereto.

The present disclosure is applicable to the case where three or more display panels are stacked.

In addition, the modification of the second exemplary embodiment describes that two λ/2 wavelength plates are used. However, the configuration is not limited thereto. Three or more λ/2 wavelength plates may be used. In this case, the sum of angles to be changed for polarized light may be set to be the same as in the case of using a single λ/2 wavelength plate. In addition, in the case where polarized light passing through three λ/2 wavelength plates is intended to be changed by angle θ, each of the λ/2 wavelength plates may be disposed to have slow axes of θ/2, θ/4, and θ/4, respectively.

Further, constituent elements appearing in the accompanying drawings and the detailed description include not only those that are essential to solving the technical problems set forth herein, but also those that are not essential to solving the technical problems but are merely used to illustrate the technology disclosed herein. Therefore, those non-essential constituent elements should not immediately be taken as being essential for the reason that they appear in the accompanying drawings and/or in the detailed description.

The exemplary embodiments above are for illustrating the technology disclosed herein, and various changes, replacements, additions, omissions, etc., can be made without departing from the scope defined by the claims and equivalents thereto.

What is claimed is:

1. A display device comprising:
a first polarizing plate having a first transmission axis;
a first display panel in which a major axis of a liquid crystal molecule in an initial alignment is oriented in a first initial alignment direction;
a λ/2 wavelength plate;
a second display panel in which a major axis of a liquid crystal molecule in an initial alignment is oriented in a second initial alignment direction different from the first initial alignment direction, the second display panel being tilted at a predetermined angle with respect to the first display panel; and
a second polarizing plate having a second transmission axis oriented in a direction different from the first transmission axis and tilted at the predetermined angle with respect to the first polarizing plate,
wherein
the first polarizing plate, the first display panel, the λ/2 wavelength plate, the second display panel, and the second polarizing plate are disposed in this order,
the first transmission axis and the first initial alignment direction are perpendicular or parallel to each other,
the second transmission axis and the second initial alignment direction are perpendicular or parallel to each other, and
a slow axis of the λ/2 wavelength plate is oriented in a direction different from the first initial alignment direction and the second initial alignment direction.

2. The display device according to claim 1, wherein an angle that the slow axis of the λ/2 wavelength plate forms with the first initial alignment direction is a half of an angle that the second initial alignment direction forms with the first initial alignment direction.

3. The display device according to claim 1, wherein an angle that the second initial alignment direction forms with the first initial alignment direction is an acute angle.

4. The display device according to claim 1, wherein the λ/2 wavelength plate includes a plurality of λ/2 wavelength plates.
